(19) United States
(12) Patent Application Publication
(10) Pub. No.: US 2020/0189824 A1
(43) Pub. Date: Jun. 18, 2020

(54) CAN BODY FOR PRODUCING A CAN INTENDED TO RECEIVE A FOOD PRODUCT STERILISED BY HEAT TREATMENT

(71) Applicant: ARDAGH MP GROUP NETHERLANDS B.V., DEVENTER (NL)

(72) Inventors: Jean-Marc LEGRESY, LA FLECHE (FR); Jeffrey JETER, ROANOKE, VA (US)

(21) Appl. No.: 16/486,250

(22) PCT Filed: Mar. 12, 2018
(86) PCT No.: PCT/EP2018/056117

§ 371 Date: Aug. 15, 2019

(30) Foreign Application Priority Data
Mar. 15, 2017 (FR) 1752119

(51) Int. Cl. B65D 79/00; B65D 1/16; B65B 25/00; A23L 3/10

(52) U.S. Cl. CPC B65D 79/005; B65D 1/165; A23V 2002/00; A23L 3/10; B65B 25/001

(57) ABSTRACT

Disclosed is a single-piece can body made of metal, for producing a two-piece can intended for receiving a food product sterilized by a heat treatment after closure of the can. This can body has the following two dimensional ratios: a) a first dimensional ratio R1, wherein R1=Dp/Db with R1 being less than or equal to 0.5, and b) a second dimensional ratio R2, wherein R2=Dp/Df with R2 being less than or equal to 0.55, wherein: Dp is the diameter of the edge of the central plate, Db is the diameter of the inner surface of the side wall of the can body, and Df is the diameter of the baseline of the peripheral groove.

### TECHNICAL FIELD TO WHICH THE INVENTION RELATES

The present invention generally relates to the field of one-piece can bodies made of metal for producing a two-piece can intended to receive a food product sterilized by heat treatment after closure of said can.

### TECHNOLOGICAL BACK-GROUND

The cans are commonly produced from a one-piece can body obtained by drawing of a sheet metal, called a “blank”, to form a bottom and a lateral wall. A lid formed of a sheet metal plate then allows closing this can. Such cans are traditionally called “two-piece” cans.

A drawing technology commonly called “DWI”, for “Draw and Wall Ironing”, makes it possible to form can bodies whose lateral wall is drawn and ironed.

The thickness of the centre of the can body bottom is substantially equal to the thickness of the blank that has been drawn. On the other hand, the thickness of the lateral wall of this can body is reduced by at least 20% with respect to the thickness of the bottom centre.

This DWI technology hence allows producing so-called “drawn and wall ironed” can bodies, which are lighter than the other types of can bodies.

But such can bodies are often not suitable for packaging food products having to be subjected to a sterilization by heat treatment after closure of the can.

Indeed, such sterilization generates in the can a pressure increase up to about 3 bars. This pressure increase is far higher for pressurized cans, in which the pressure may reach 5 bars.

Now, the lateral wall is very little deformed under the effect of this pressure. Only the bottom and the lid are hence liable to be deformed and to allow the expansion of the can, to limit the inner pressure increase during the sterilization process.

For that purpose, certain can bodies have a flat-type deformable bottom, i.e. a bottom including a central plate surrounded by a peripheral strip including at least one annular moulding, itself surrounded by a generally U-shaped peripheral groove.

But most of the flat bottoms have a deformation of the bistable type, generating a “click-clack” effect (sometimes also called “oil can effect”), which is expressed, after a move to a displaced position, by a sudden return of the central plate to the initial position upon decrease of the inner pressure.

Now, in practice, this “click-clack” effect is liable to pose problems. Indeed, for example, the bottom may return to the initial position at the can opening, with a risk that its content be projected through the upper opening.

### OBJECT OF THE INVENTION

The present invention has for interest to provide a new can body that is particularly suitable for implementing sterilization operations.

In particular, the can body according to the invention includes a flat-type bottom that, unexpectedly, has for interest to deform without “click-clack” effect during the sterilization operations.

The bottom in question hence does not risk suddenly returning to the initial position upon decrease of the inner pressure.

To that end, the present invention proposes a one-piece can body made of metal for producing a two-piece can intended to receive a food product sterilized by heat treatment after closure of said can.

The can body has a lateral wall, a lower edge of which is connected to a bottom, wherein said bottom has a maximum thickness lower than 0.4 mm, the minimum thickness of said lateral wall being comprised between 30% and 60% of said maximum thickness of said bottom.

The lateral wall, of generally cylindrical tubular shape, has an inner surface whose diameter Db is higher than 70 mm.

The bottom includes:
a central circular plate, whose edge has a diameter Dp,
an annular peripheral strip including at least one annular moulding, which surrounds said central plate and which is arranged concentrically with said bottom, and
a generally U-shaped peripheral groove, connected to said lower edge of the lateral wall and opening towards the inside of said can body.

The peripheral groove has an outer surface, a base line of which is inscribed into a circle of diameter Df.

And according to the invention, the can body has the following two dimensional ratios:

a) a first dimensional ratio R1, wherein

R1=Dp/Db

with R1 lower than or equal to 0.5,

and

b) a second dimensional ratio R2, wherein

R2=Dp/Df

with R2 lower than or equal to 0.55.

Other non-limitative and advantageous features of the can body according to the invention, taken individually or according to all the technically possible combinations, are the following:
the first dimensional ratio R1 (Dp/Db) is lower than or equal to 0.45, preferably from 0.40 to 0.44; and the second dimensional ratio R2 (Dp/Df) is lower than or equal to 0.5, preferably from 0.42 to 0.46;
said central plate has a thickness from 0.2 to 0.4 mm, preferably from 0.22 to 0.37 mm;
the central plate shows a sag (whose convexity is oriented towards the outside), which corresponds to the distance between two parallel planes passing through its edge and its centre, respectively, wherein said sag has a value lower than or equal to 1 mm;
said at least one moulding has a depth F from 0.5 to 3 mm, preferably from 0.7 to 1.4 mm;
the lateral wall has a diameter Db higher than 80 mm, advantageously comprised between 80 and 85 mm; preferably, the lateral wall has a diameter Db of 83 mm, the central plate has a diameter Dp comprised between 34 and 35 mm, and the base line of the peripheral groove is inscribed into a circle having a diameter Df comprised between 78 and 79 mm;
the annular peripheral strip includes two annular mouldings;
the annular peripheral strip includes an annular moulding that surrounds the central plate, and an intermediate crown arranged between said annular moulding and the peripheral groove.

The present invention also relates to a two-piece can, intended to receive a food product sterilized by heat treatment after closure of said can, which can comprise:
a can body according to the invention, and
a lid assembled to the lateral wall of said can body to close the latter.

The invention also relates to the method for producing a can body according to the invention, obtained by a Draw and Wall Ironing (DWI) technique.

The invention also relates to a method for packaging and sterilizing a food product inside a two-piece can.

The method comprises:
a step of providing a can body according to the invention,
a step of filling said can body,
a step of closing said can body with a lid, for producing a two-piece can, and
a step of sterilizing by heat treatment said food product added into said can body.

### DETAILED DESCRIPTION OF AN EXEMPLARY EMBODIMENT

The following description in relation with the appended drawings, given by way of non-limitative example, will allow a good understanding of what the invention consists of and of how it can be implemented.

In the appended drawings:

FIG. 1 is a schematic cross-sectional view, along a longitudinal sectional plane, of a two-piece can according to the invention;

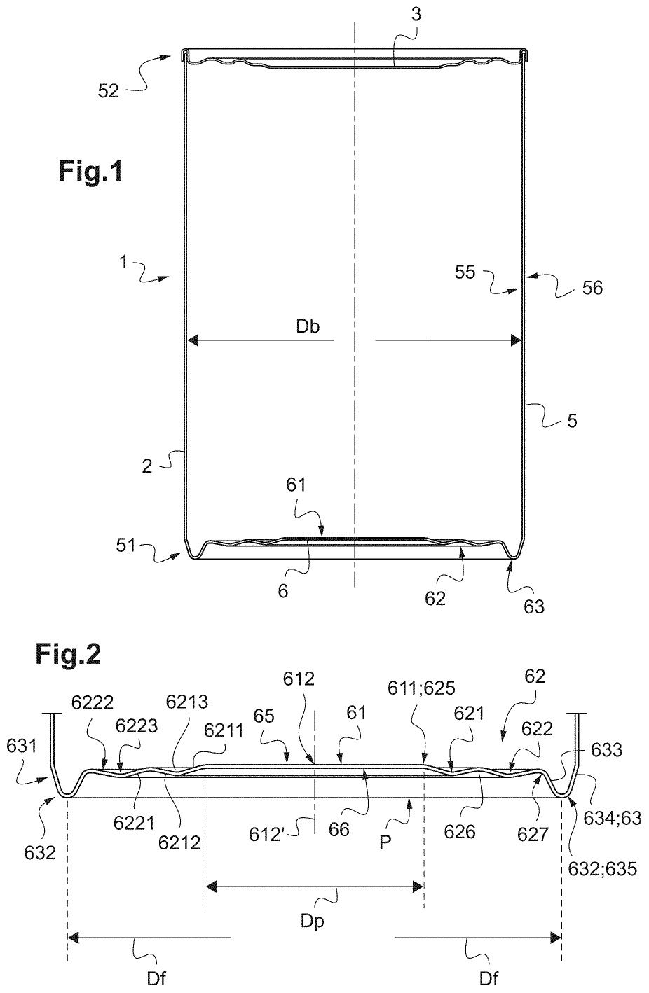

FIG. 2 is a partial and enlarged view of the can according to FIG. 1, schematically showing a cross-section of the can body bottom;

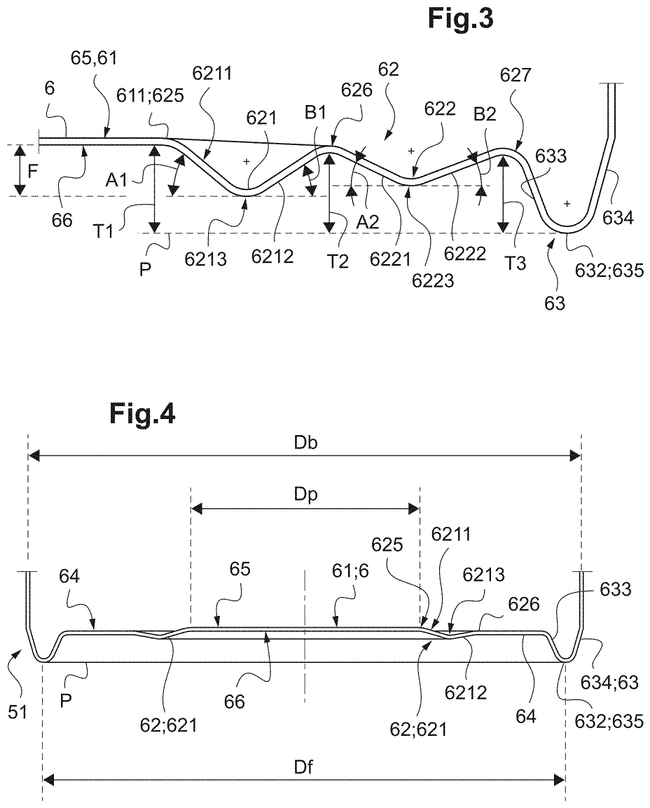

FIG. 3 is a partial and enlarged view of the can body bottom according to FIG. 2, schematically showing the cross-section of its annular peripheral strip;

FIG. 4 is a partial and enlarged view of an alternative embodiment for the can according to FIG. 1, schematically showing a cross-section of its can body bottom.

### CAN AND CAN BODY

In FIG. 1 is shown a can 1 intended to receive a food product.

This can 1, tightly closed, is suitable for the sterilization by heat treatment of its content. Indeed, as will be explained hereinafter, this can 1 has a flat-type deformable bottom that, during sterilization operations, has for interest to deform without “click-clack” effect.

The can 1 consists of two pieces: a can body 2 and a lid 3, tightly assembled to each other.

The can body 2 is a one-piece body made of metal (for example, stainless steel or aluminium).

The can body 2 is advantageously obtained by a Draw and Wall Ironing (DWI) technique. The can body 2 is then advantageously obtained by drawing a sheet metal, called a “blank”, to form a bottom and a lateral wall.

This can body 2 hence includes two main parts: a lateral wall 5 and a bottom 6.

The lateral wall 5, once drawn and ironed, has a generally cylindrical tubular shape.

This lateral wall 5 is delimited by a lower edge 51 and an upper edge 52 (free before the positioning of the lid 3).

This lateral wall 5 has also two opposite surfaces: an inner surface 55 (intended to come into contact with the packaged product) and an outer surface 56. The distance between these two opposite surfaces 55, 56 defines the thickness of the lateral wall 5.

Moreover, the inner surface 55 of this lateral wall 5 defines a diameter Db (FIG. 1).

This diameter Db is higher than 70 mm, or even higher than 75 mm. For example, this diameter is comprised in the range from 83 mm to 99 mm.

Mouldings may be formed on this lateral wall 5 to increase its resistance to the external pressure.

The bottom 6 is integrally connected to the lower edge 51 of the lateral wall 5.

As described in more details hereinafter in relation with FIG. 2, the bottom 6 is of the “flat bottom” type, with:
a circular central plate 61, delimited by a circular edge 611 having a diameter Dp,
an annular peripheral strip 62 including at least one annular moulding 621, 622, that surrounds this central plate 61 and that is arranged concentrically with the bottom 6, and
a generally U-shaped peripheral groove 63, integrally connected with the lower edge 51 of the lateral wall 5 and opening towards the inside of the can body 2.

The bottom 6 also includes two opposite surfaces: an inner surface 65 (intended to come into contact with the product) and an outer surface 66. These two opposite surfaces 65, 66 define the thickness of this bottom 6.

The peripheral groove 63 has an outer surface 631, a base line (or annular foot) 632 of which is inscribed into a (virtual) circle having a diameter Df.

The peripheral groove 63 has also:
a first, inner wall 633, connected to the annular strip 62, and
a second, outer wall 634, connected to the lateral wall 5.

These two walls 633, 634 are connected by a junction line 635, forming the base line 632 and having an arc-of-a-circle cross-section with, for example, an outer radius comprised between 0.4 mm and 1.6 mm.

The circular central plate 61 and the annular peripheral strip 62 are offset with respect to the general plane P passing through the base line 632 of the peripheral groove 63, towards the inside of the can body 2.

For example, the circular central plate 61 is offset by a distance comprised between 2 and 5 mm with respect to the general plane P passing through the base line 632.

To prevent the “click-clack” phenomenon, the can body 2 has two particular dimensional ratios.

On one hand, a first dimensional ratio R1 is defined by the following formula:

R1=Dp/Db

wherein Dp is the diameter of the edge 611 of the central plate 61,

Db is the diameter of the inner surface 55 of the lateral wall 5 of the can body 2,

with R1 lower than or equal to 0.5.

On the other hand, a second dimensional ratio R2 is defined by the following formula:

R2=Dp/Df

wherein Dp is the diameter of the edge 611 of the central plate 61,

Df is the diameter of the base line 632 of the peripheral groove 63, with R2 lower than or equal to 0.55.

According to a preferred embodiment, the can body 2 has the following two dimensional ratios:
the first dimensional ratio R1 (Dp/Db) is lower than or equal to 0.45, preferably from 0.40 to 0.44, and
the second dimensional ratio R2 (Dp/Df) is lower than or equal to 0.5, preferably from 0.42 to 0.46.

Still according to a preferred embodiment, the lateral wall 5 has a diameter Db higher than 80 mm, still preferably between 80 and 85 mm.

In this preferred embodiment, the can body 2 has advantageously the following technical features:
the lateral wall 5 has a diameter Db of 83 mm,
the central plate 61 has a diameter Db comprised between 34 and 35 mm, and
the base line 632 of the peripheral groove 63 is inscribed into a circle having a diameter Df comprised between 78 and 79 mm.

Moreover, the can body 2 has other structural features liable to participate in the prevention of the “click-clack” phenomenon.

The central plate 61 possibly shows a sag, i.e. a convex shape directed towards the outside.

This sag is defined by the distance between two parallel planes passing through its edge 611 and its centre 612 (through which passes a longitudinal axis 612′), respectively.

The sag in question has advantageously a value lower than or equal to 1 mm.

The annular peripheral strip 62 advantageously includes one or several annular mouldings 621, 622.

Generally, by “annular moulding”, it is meant a groove or a corrugation whose concavity is open towards the inside. Each annular moulding 621, 622 herein protrudes under the general plane passing through the central plate 61.

Each annular moulding 621, 622 has advantageously a depth F from 0.5 to 3 mm, preferably from 0.7 to 1.4 mm (FIG. 3).

In other words, the lower surface of each annular moulding 621, 622 is offset by a distance comprised between 1.5 and 4.5 mm with respect to the general plane P passing through the base line 632 (FIG. 3).

According to FIGS. 1 to 3, the annular peripheral strip 62 includes two annular mouldings: an inner annular moulding 621 (on the side of the central plate 61) and an outer annular moulding 622 (remote from the central plate 61).

Each annular moulding 621, 622 has herein two frustoconical surfaces:
an inner frustoconical surface 6211, 6221 (on the side of the central plate 61), whose virtual apex is located opposite the upper surface 65 of the bottom 6 and advantageously centred to the longitudinal axis 612′, and
an outer frustoconical surface 6212, 6222 (remote from the central plate 61), whose virtual apex is located opposite the lower surface 66 of the bottom 6 and advantageously centred to the longitudinal axis 612′.

Each frustoconical surface 6211, 6212 and 6221, 6222 of an annular moulding 621, 622 defines an angle comprised between 3° and 40° with respect to a plane extending parallel to the general plane P passing through the base line 632.

Advantageously, in each annular moulding 621, 622, the angle A1, A2 formed by the inner frustoconical surface 6211, 6221 is greater than the angle B1, B2 formed by the associated outer frustoconical surface 6212, 6222 (FIG. 3).

The two frustoconical surfaces 6211, 6212 and 6221, 6222 of an annular moulding 621, 622 are connected by a rounded cross-section junction line 6213, 6223 (median) whose radius is for example comprised between 1 and 2 mm (for example, 1.5 mm).

Each annular moulding 621, 622 is also delimited by two junction lines, i.e.:
an inner junction line 625, arranged between the central plate 61 and the inner annular moulding 621, forming the edge 611 of the central plate 61,
an intermediate junction line 626, arranged between the two annular mouldings 621, 622, and
an outer junction line 627, arranged between the outer annular moulding 622 and the peripheral groove 63.

Each of these junction lines 625, 626, 627 has a rounded cross-section whose radius is for example comprised between 1 and 2 mm (for example, 1.5 mm).

Herein, the junction lines 625, 626 and 627 are offset by a distance T1, T2 and T3, respectively, which decreases successively from the inside to the outside, with respect to the general plane P passing through the base line 632 (FIG. 3).

These junction lines 625, 626 and 627 are advantageously inscribed, at least approximately, into a virtual frustoconical surface whose virtual apex is located opposite the upper surface 65 of the bottom 6.

By annular moulding “depth”, it is advantageously meant the dimension F, measured parallel to the longitudinal axis 612′, defined between, on the one hand, its two junction lines 625, 626 or 626, 627 (as the case may be its junction line the most distant from the general plane P passing through the base line 632), and on the other hand, its median junction line 6213, 6223.

According to an alternative embodiment shown in FIG. 4, the annular peripheral strip 62 includes only one annular moulding, which surrounds the central plate 61 and which is arranged concentrically with the bottom 6.

This single annular moulding according to FIG. 4 is identical, or at least similar, to the inner annular moulding 621 according to FIGS. 1 to 3. For the sake of simplification, the references used to describe the inner annular moulding 621 will be used to describe this single annular moulding.

Hence, here again, this single annular moulding 621 has herein two frustoconical surfaces:
an inner frustoconical surface 6211 (on the side of the central plate 61), whose virtual apex is located opposite the upper surface 65 of the bottom 6, and
an outer frustoconical surface 6212 (remote from the central plate 61), whose virtual apex is located opposite the lower surface 66 of the bottom 6.

Each frustoconical surface 6211, 6212 of this annular moulding 621 defines an angle comprised between 3° and 40° with respect to a plane extending parallel to the general plane P passing through the base line 632.

Here again, the angle formed by the inner frustoconical surface 6211 is greater than the angle formed by the outer frustoconical surface 6212.

The two frustoconical surfaces 6211, 6212 are connected by a rounded cross-section junction line 6213 whose radius is for example comprised between 1 and 2 mm (for example, 1.5 mm).

This single annular moulding is also delimited by two junction lines, i.e.:
an inner junction line 625, arranged between the central plate 61 and the single annular moulding 621, and
an outer junction line 626, arranged between the single annular moulding 621 and the peripheral groove 63.

Herein, the outer junction line 626 is connected to the peripheral groove 63 through an intermediate crown 64 extending parallel to the general plane P passing through the base line 632.

In other words, the annular peripheral strip 62 includes:
an annular moulding 621, that surrounds the central plate 61, and
an intermediate crown 64, arranged between said annular moulding 621 and the peripheral groove 63.

Moreover, the bottom 6 has generally a maximum thickness e1 lower than 0.4 mm.

In particular, the central plate 61 has advantageously a thickness from 0.2 to 0.4 mm, preferably from 0.22 to 0.37 mm.

For its part, the minimum thickness e2 of the lateral wall 5 is advantageously comprised between 30% and 60% of the maximum thickness e1 of the bottom 6.

For example, the can body 2 has the following thicknesses:
a maximum thickness e1 of the bottom 6 comprised between 0.29 and 0.32 mm, and
a minimum thickness e2 of the lateral wall 5 comprised between 0.155 and 0.175 mm.

Still generally, the height of the lateral wall 5 of the can body 2 (corresponding approximately to the height of the can 1) is advantageously comprised between 1.5 and 3 times the width thereof (for example, between 1.7 and 2).

The lid 3 is assembled to the lateral wall 5 of the can body 2, and in particular to the upper edge 52 thereof, for closing it.

Conventionally, the lid 3 may be made of metal.

It may include means for its easy opening, for example a tearable portion that is delimited by a score line and that is equipped with a pull ring for its separation from the remainder of the lid.

Packaging and Sterilization Method

The present invention also relates to the method for packaging and sterilizing a food product inside a two-piece can.

Indeed, the can according to the invention may be produced with an optimized quantity of material and may undergo without damage a sterilization heat treatment (in particular, at its bottom 6).

This method comprises:
a step of providing a can body 2 as described hereinabove in relation with FIG. 1, for example as a step of producing it using a DWI technology,
a step of filling the can body 2 with the food product to be packaged,
a step of closing said can body 2 with a lid 3, for producing the two-piece can 1 (FIG. 1), and
a step of sterilizing by heat treatment the food product added into said can body 2.

During the closing step, the lid 3 is added on the upper edge 52 of the lateral wall 5 of the can body 2 to obtain the can.

This fastening of the lid 3 to the can body 2 is for example performed by a crimping technique.

Moreover, the sterilization step advantageously involves heating the content of the can to a temperature of about 110° C. to 150° C. (preferably between 110 and 135° C.).

Hence, when the can 1 is heated, the increase of its inner pressure causes the deformation, temporary and reversible, of its bottom 6: the bottom 6 is moved towards the general plane P passing through the base line 632 of the peripheral groove 63.

The distance of displacement of the central plate 61 to the deformed position, from the initial position, is for example of 4 mm under a pressure of 1.2 bar.

This volume increase allows limiting the effective pressure in the can 1, while keeping values that do not risk damaging it.

The structure of the bottom 6 has for interest to allow this displacement without “click-clack” effect. Hence, there is no risk that the bottom 6 suddenly returns to its initial position, for example at the can opening.

1. A one-piece can body made of metal,
for producing a two-piece can intended to receive a food product sterilized by heat treatment after closure of said can,
wherein said can body (2) has a lateral wall (5), a lower edge (51) of which is connected to a bottom (6),
wherein said bottom (6) has a maximum thickness (e1) lower than 0.4 mm, the minimum thickness (e2) of said lateral wall (5) being comprised between 30% and 60% of said maximum thickness (e1) of said bottom (6),
wherein said lateral wall (5), of generally cylindrical tubular shape, has an inner surface (55) whose diameter Db is higher than 70 mm,
wherein said bottom (6) includes:
a central circular plate (61), whose edge (611) has a diameter Dp,
an annular peripheral strip (62) including at least one annular moulding (621, 622), which surrounds said central plate (61) and which is arranged concentrically with said bottom (6), and
a generally U-shaped peripheral groove (63), connected to said lower edge (51) of the lateral wall (5) and opening towards the inside of said can body (2),
wherein said peripheral groove (63) has an outer surface (631), a base line (632) of which is inscribed into a circle of diameter Df,
wherein said can body (2) has the following two dimensional ratios:
a) a first dimensional ratio R1, wherein
R1=Dp/Db
with R1 lower than or equal to 0.5
and
b) a second dimensional ratio R2, wherein
R2=Dp/Df
with R2 lower than or equal to 0.55.

2. The metal can body according to claim 1, wherein:
the first dimensional ratio R1 (Dp/Db) is lower than or equal to 0.45, preferably from 0.40 to 0.44, and
the second dimensional ratio R2 (Dp/Df) is lower than or equal to 0.5, preferably from 0.42 to 0.46.

3. The metal can body according to claim 1, wherein said central plate (61) has a thickness from 0.2 to 0.4 mm, preferably from 0.22 to 0.37 mm.

4. The metal can body according to claim 1, wherein the central plate (61) shows a sag, which corresponds to the distance between two parallel planes passing through its edge (611) and its centre (612), respectively, wherein said sag has a value lower than or equal to 1 mm.

5. The metal can body according to claim 1, wherein said at least one moulding (621, 622) has a depth F from 0.5 to 3 mm, preferably from 0.7 to 1.4 mm.

6. The metal can body according to claim 1, wherein the lateral wall (5) has a diameter Db higher than 80 mm,
preferably comprised between 80 and 85 mm.

7. The metal can body according to claim 6, wherein:
the lateral wall (5) has a diameter Db of 83 mm,
the central plate (61) has a diameter Dp comprised between 34 and 35 mm, and
the base line (632) of the peripheral groove (63) is inscribed into a circle having a diameter Df comprised between 78 and 79 mm.

8. The metal can body according to claim 1, wherein the annular peripheral strip (62) includes two annular mouldings (621, 622).

9. The metal can body according to claim 1, wherein the annular peripheral strip (62) includes:
an annular moulding (621), that surrounds the central plate (61), and
an intermediate crown (64), arranged between said annular moulding (621) and the peripheral groove (63).

10. A two-piece can, intended to receive a food product sterilized by heat treatment after closure of said can, which can (1) comprise:
a can body (2) according to claim 1, and
a lid (3) assembled to the lateral wall (5) of said can body (2) to close the latter.

11. A method for producing a can body (2) according to claim 1, wherein it is obtained by a Draw and Wall Ironing (DWI) technique.

12. A method for packaging and sterilizing a food product inside a two-piece can (1), wherein said method comprises:
a step of providing a can body (2) according to claim 1,
a step of filling said can body (2),
a step of closing said can body (2) with a lid (3), for producing a two-piece can (1), and
a step of sterilizing by heat treatment said food product added into said can body (2).

13. The metal can body according to claim 2, wherein said central plate (61) has a thickness from 0.2 to 0.4 mm,
preferably from 0.22 to 0.37 mm.

14. The metal can body according to claim 2, wherein the central plate (61) shows a sag, which corresponds to the distance between two parallel planes passing through its edge (611) and its centre (612), respectively, wherein said sag has a value lower than or equal to 1 mm.

15. The metal can body according to claim 3, wherein the central plate (61) shows a sag, which corresponds to the distance between two parallel planes passing through its edge (611) and its centre (612), respectively, wherein said sag has a value lower than or equal to 1 mm.

16. The metal can body according to claim 2, wherein said at least one moulding (621, 622) has a depth F from 0.5 to 3 mm, preferably from 0.7 to 1.4 mm.

17. The metal can body according to claim 3, wherein said at least one moulding (621, 622) has a depth F from 0.5 to 3 mm, preferably from 0.7 to 1.4 mm.

18. The metal can body according to claim 4, wherein said at least one moulding (621, 622) has a depth F from 0.5 to 3 mm, preferably from 0.7 to 1.4 mm.

19. The metal can body according to claim 2, wherein the lateral wall (5) has a diameter Db higher than 80 mm, preferably comprised between 80 and 85 mm.

20. The metal can body according to claim 3, wherein the lateral wall (5) has a diameter Db higher than 80 mm, preferably comprised between 80 and 85 mm.
